(19) United States
(12) Patent Application Publication
(10) Pub. No.: US 2013/0034645 A1
(43) Pub. Date: Feb. 7, 2013

(54) FUNCTIONAL FOOD COMPOSITION AND ITS USE IN DIET FOOD

(71) Applicants: Mayyas Mohammad Ahmad Al-Remawi, Amman (JO); Ibrahim Abdulla Mustafa Maghrabi, Taif (SA)

(72) Inventors: Mayyas Mohammad Ahmad Al-Remawi, Amman (JO); Ibrahim Abdulla Mustafa Maghrabi, Taif (SA)

(73) Assignee: TAIF UNIVERSITY, College of Pharmacy of Taif University, Taif (SA)

(21) Appl. No.: 13/462,591

(22) Filed: May 2, 2012

(51) Int. Cl. A23L 1/307; A23L 1/30; A23L 1/0534; A23L 1/0532

(52) U.S. Cl. 426/532; 426/573; 426/575; 426/548; 426/648

(57) ABSTRACT

The present invention relates to a functional food composition, comprising: a thickening agent in an amount from 0.1 to 50% by weight, preferably 1 to 20% by weight; a raising and/or a bulk enhancing agent in an amount from 0.1 to 10% by weight, preferably 0.5 to 3% by weight; at least one edible oil in an amount from 0.1 to 20% by weight, preferably 2 to 10% by weight; at least one additive selected from the group consisting of flavor, surfactant, sweetener, preservative and coloring agent; and water in an amount from 20 to 90% by weight and the use of said functional food composition.

The present invention relates to a functional food composition and its use in diet food.

The appearance of new eating habits with more sugar and fat and less physical activity leads to the presence of a large number of people suffering from problems of being overweight or even obese. Obese or overweight are people suffering from abnormal accumulation of excess body fat. The difference between obese and overweight is dependent on the amount of fat deposited and is determined by measuring the body mass index (BMI). The BMI compares weight and height and defines people having a BMI is between 25 k g/m² and 30 kg/m² as overweight (pre-obese and as obese when it is greater than 30 kg/m²).

Obesity is considered as a health problem. Where it increases the likelihood of various diseases is enhanced, particularly heart failure, type 2 diabetes, breathing difficulties, cancer and osteoarthritis. Obesity is most commonly caused by a combination of excessive dietary calories, lack of physical activity and genetic susceptibility

There are many methods for the treatment of obesity:

Dieting where a person is subjected to many dieting substances including the use of low fat diet, low carbohydrate, low calorie diet and extremely low calorie diets. However, most of the food used in dieting is unpleasant in taste when compared with those of high-fat or sugar rich food. Also, dieting subjects the body to starvation and requires patience and the power to control ones appetite. In addition, dieting leads to loss of enjoying many delicious foods taste. Consequently, these diets are not recommended for general use as they are associated with adverse side effects such as loss of lean muscle mass, increased risks of gout, and electrolyte imbalances. Most people attempting these diets must be monitored closely by a physician to prevent complications.

Subjecting the body to physical exercise like walking, running or cycling are the most effective ways to reduce body fat. However, many people suffering from lack of time to do the exercise since it requires doing exercise regularly. In addition, doing exercises requires patience and it is not a favorable choice by the obese patients.

Entering a weight loss program like Weight Watchers, Overeaters Anonymous and Jenny Craig often requires lifestyle changes. In weight loss programs patients are forced to eat smaller quantity of meals, cutting down a certain types of food and in many occasions making exercise. Thus, weight loss programs combine the disadvantages of both, dieting and doing exercises.

Some commonly used medications to treat obesity are orlistat, sibutramine and rimonabant. In 2010, US Food and Drug Administration (FDA) raised a concern regarding sibutramine. The note was that sibutramine increases the risk of heart attacks and strokes in patients with a history of cardiovascular disease. Rimonabant did not receive approval in the United States or Canada due to safety concerns. It is obvious that long-term health benefits of these treatments remain unclear.

In general, the use of surgical intervention in the treatment of obesity is possible. However, as every operation may have complications, surgery is only recommended for severely obese people (BMI>40) who have failed to lose weight following dietary modification and pharmacological treatment.

In some cases, the use of dietary fibers can be used to control body weight. Dietary fibers contain low caloric or non-digestible material. However, dietary fibers can have unpleasant taste and, upon their addition on the diet, they can deteriorate the taste of the diet.

One approach is the use of low caloric carbohydrates which are slowly digestively absorbed and not closely associable with obesity as compared with carbohydrates which are digestively absorbed rapidly. However, this is a kind of restriction on the food intake desired by the patients.

It is therefore an object of the present invention to provide a functional food composition which overcomes the drawbacks of the prior art, particularly causes a decrease in the digestion rate of food and in food absorption. It is a further object to provide a functional food composition which does not feature the disadvantages of diet food known from the prior art, particularly bad taste or a limitation in the food selection.

This object is achieved by a functional food composition, comprising:
a) a thickening agent in an amount from 0.1 to 50% by weight, preferably 1 to 20% by weight;
b) a raising and/or a bulk enhancing agent in an amount from 0.1 to 10% by weight, preferably 0.5 to 3% by weight;
c) at least one edible oil in an amount from 0.1 to 20% by weight, preferably 2 to 10% by weight;
d) at least one additive selected from the group consisting of flavor, surfactant, sweetener, preservative and coloring agent; and
e) water in an amount from 20 to 90% by weight.

In some embodiments, the thickening agent can include a polysaccharide and/or a protein as well as various derivatives. Preferred embodiments include those thickening agents which are suitable for consumption and those which have a history of use for human consumption and those which have a large margin of safety. Examples of polysaccarides and derivatives of polysaccharides include starch, modified starch, dextrin, cellulose, microcrystalline cellulose, fermented cellulose, cellulosics (such as carboxymethyl cellulose sodium, hydroxypropyl cellulose, hydroxypropylethyl cellulose), alginates (acid, potasium, sodium, ester, etc.), agar, carrageenan, furcellaran, guar gum, locust bean gum, tamarind seed polysaccharides, tara gum, gum arabic, tragacanth gum, karaya gum, pectin, xanthan gum, pullulan, gellan gum, fucoidan, furcellaran, chitin, chitosan, dextrins, cyclodextrins, and the like. Examples of proteins include collagen, egg whites, gelatin, whey, milk protein, soy protein, hydrolyzed protein, and derivatives thereof In some embodiments, a combination of thickeners can be used.

In some embodiments, the raising agent can be a carbonate and/or a bicarbonate, preferably the raising agent can be sodium bicarbonate.

In a further preferred embodiment, the bulk enhancing agent is citric acid. In some embodiments, citric acid acts as a bulk enhancing agent by assisting in the generation of greater volume by assisting in the production of a gas, such as CO₂, by interacting with one or more other ingredients.

Preferred, the at least one edible oil is selected from the group consisting of medium chain fatty acids and essential fatty acids, preferably the at least one edible oil is selected from the group consisting of olive oil, coconut oil and linseed oil.

In one embodiment, the flavor is citric acid, chocolate flavor, banana flavor, cheese flavor, pizza flavor, strawberry flavor, honey flavor and/or orange flavor.

In another preferred embodiment, the surfactant is polysorbate 20, polysorbate 40, polysorbate 60, polysorbate 65 and/or polysorbate 80.

Preferably, the sweetener is aspartame and/or glycerin.

In some embodiments, the preservative is sodium benzoate.

The object is further achieved by the use of the inventive functional food composition as diet food or as an ingredient in diet food.

Finally, the object is achieved by the use of the inventive functional food composition according to claim 1 for enhancing the palatability of diet food.

Surprisingly, it was found that the functional food composition according to the present invention allows the preparation of food having a positive effect on the decrease of body weight. It was further surprisingly found that the inventive composition can be used for the preparing of diet food having a pleasant taste and allowing normal nutrition without any side effects as weight gaining.

A product is provided that can be used easily (consumer friendly) as a pharmaceutical composition, functional food or food additive, in order to decrease body weight without having the problems associated with dieting or exercise.

An emulgel structure can be formed once the functional food components a-d are wetted with water. An emulgel structure is one having properties of a gel and an emulsion. The gel can be a colloid in which a solid disperse phase forms a network in combination with the fluid continuous phase, resulting in a viscous semirigid sol. The emulsion can be a suspension of small globules of one liquid within a second liquid into which the first does not completely dissolve. An emulgel can have an emulsion formed within the structure of a gel or a gel within the structure of an emulsion. In some cases, an emulgel can occur with an emulsion having a large percentage of jellifying agent. Without wishing to be limited by theory, it is believed that the produced composition is not easily digested in the stomach and forms water-insoluble masses due to the hydrophobic nature of the edible oils and the gelling nature of thickening agent under acidic conditions. This is why the inventive functional food composition remains in the stomach for longer time and upon the ingestion of an ordinary meal, the composition will be mixed up with food and form a matrix system of small particles containing the food. Once the materials leave the stomach and are released to the small intestine. it is expected that the emulgel will form a sustaining release matrix system around food products. In order to complete digestion of food, it should be exposed directly to digestive enzymes. However, due to coating the food with the emulgel structures, the food will not be readily available for digestion. Food will be released depending on the erosion rate of the formed hydrophobic matrix. The matrix will be dissolved in a very slow rate which causes a slow release of the food. The slow release of food will slow down the absorption process. This means that large quantity of food will pass the intestine without absorption. The release of the matrix components would not have a negative impact to the obese patients. All components are safe and considered by the FDA as GRAS (generally recognized as safe). Rather some components will have a positive impact upon its absorption and others will be slowly absorbed.

Sodium alginate chiefly consists of the sodium salt of alginic acid which is a mixture of polyuronic acids composed of D-mannuronic acid and L-guluronic acid. Its use as a pharmaceutical excipient is currently limited to experimental hydrogel systems. It is used in the weight loss industry as an appetite suppressant. It is generally recognized as safe (GRAS) material and accepted in Europe as a food additive. It is further included in the FDA Inactive Ingredients Guide (oral suspensions and tablets) and in nonparenteral medicines licensed in the UK. Except where the context indicates otherwise, sodium alginate can include various salt forms, such as sodium, potassium, calcium, as well as acid and ester forms and combinations thereof, and it can be added in one salt/acid/ester form or mixture of forms, and converted some other salt/acid/ester form or mixture of forms upon addition to a mix, a food, or a functional food, or after addition to a mix, a food, or a functional food.

Sweeteners can in various can in various embodiments be nutritive, non-nutritive, and partially nutritive materials, and can be a purified compound or a less or non-purified material or a mixture of compounds. Sweeteners can include aspartame, sucralose, saccharin, cyclamates, stevia, agave, sugar, glucose, fructose, sucrose, oligosaccharides, monosaccharides, disaccharides, trisaccharides, maltose, Neotame™, acesulfame potassium, maple syrup, honey, molasses, inulin, FOS, corn syrup, high fructose corn syrup, etc., and combinations thereof Sweeteners can be in various forms including liquids, solids, solutions, suspensions, emulsions, etc. Preferred embodiments include those sweeteners which are suitable for consumption and those which have a history of use for human consumption and those which have a large margin of safety.

Aspartame is widely used in oral pharmaceutical formulations, beverages and food products as an intense sweetener and is generally regarded as a nontoxic material (GRAS). It is accepted for use as a food additive in Europe and included in the FDA Inactive Ingredients Guide (oral powder for reconstitution) as well as in nonparenteral medicines licensed in the UK.

Citric acid is used as a flavor enhancer because of its tart and acidic taste. Citric acid monohydrate is also used as a sequestering agent and antioxidant synergist. It is part of anti-coagulant citrate solutions. Therapeutically, preparations containing citric acid have been used to dissolve renal calculi. It is GRAS listed. The anhydrous form is accepted for use as a food additive in Europe. It is included in the FDA Inactive Ingredients Guide (inhalations, IM, IV, and other injections, ophthalmic preparations, oral capsules, solutions, suspensions and tablets, topical, and vaginal preparations) and included in nonparenteral and parenteral medicines licensed in Japan and the UK. Citric acid in its fully acidified form is a polycarboxylic acid with three acidified carboxyl groups per molecule. Except where the context indicates otherwise, citric acid can include the fully acidified form, a partially acidified form with only two acidified carboxyl groups per molecule, a partially acidified form with only one acidified carboxyl group per molecule, a form having no acidified carboxyl groups per molecule, and mixtures thereof. In some embodiments, citric acid can be added that has one combination of forms, and which then changes to a different combination of forms after being added to a mixture, a food or a functional food, or which is changed after addition to a mix, a food or a functional food, such as through the addition of other materials, such as an acidic, a basic, or other material.

Sodium bicarbonate it is generally used in pharmaceutical formulations as a source of carbon dioxide. It is also widely used to produce or maintain an alkaline pH and GRAS listed. It is accepted for use as a food additive in the UK, included in the FDA Inactive Ingredients Guide (injections, ophthalmic preparations, oral capsules, solutions and tablets) and in parenteral and nonparenteral medicines licensed in the UK. In some embodiments, sodium carbonate can be converted to a different form, or a mixture of forms, having a different counter ion or a different degree of basicity upon or after addition to a mix, a food, or a functional food.

Carbonate/bicarbonate can include various salt forms and various degrees of acidity/basicity as can be understood from the context. Except where indicated otherwise, a reference to carbonate or a reference to bicarbonate can include a mixture of carbonate and bicarbonate. In some embodiments, the counter ion can change and/or the relative amounts of carbonate and bicarbonate can change when the carbonate or bicarbonate is added or after the carbonate or bicarbonate is added to a mix, a food, or a functional food. In some embodiments, at least a portion of the carbonate/bicarbonate can be converted to carbon dioxide.

Emulsifying agents such as polysorbates are widely used in cosmetics and food products. Polysorbates are used as emulsifying agent, nonionic surfactant, solubilizing agent, wetting and dispersing/suspending agent. Polysorbates 60, 65 and 80 are GRAS listed. Polysorbates 20, 40, 60, 65, and 80 are accepted as food additives in Europe. Polysorbates 20, 40, 60, and 80 are included in the FDA Inactive Ingredients Guide (IM, IV, oral, rectal, topical and vaginal preparations). Polysorbates are included in parenteral and nonparenteral medicines licensed in the UK.

Glycerin is used in a wide variety of pharmaceutical formulations including oral, otic, ophthalmic, topical and parenteral preparations. It is also used in cosmetics and as a food additive. It is used as antimicrobial preservative, emollient, humectant, plasticizer, solvent, sweetening agent and tonicity agent. It is GRAS listed and accepted as a food additive in Europe. It is further included in the FDA Inactive Ingredients Guide (inhalations, injections, nasal, ophthalmic, oral capsules, solutions, suspensions and tablets, otic, rectal, topical, transdermal, and vaginal preparations) and included in nonparenteral and parenteral medicines licensed in the UK.

Sodium benzoate is used primarily as an antimicrobial preservative in cosmetics, foods and pharmaceuticals and is also GRAS listed. It is accepted as a food additive in Europe, included in the FDA Inactive Ingredients Guide (dental preparations, IM and IV injections, oral capsules, solutions and tablets, rectal, and topical preparations) and Included in nonparenteral medicines licensed in the UK.

Oils Containing Essential Fatty Acid and/or Medium Chain Fatty Acids:

Essential fatty acids (EFAs) are fatty acids that cannot be constructed within an organism (generally all references are to humans) from other components by any known chemical pathways. Therefore they must be obtained from food. There are generally two families of EFAs: omega-3 and omega-6 fatty acids. Fats from each of these families are essential since the body can convert one omega-3 to another omega-3, for example, but cannot create an omega-3 from omega-6 or saturated fats. Omega-9 fatty acids are not essential in humans, because humans generally possess all the enzymes required for their synthesis. Exceptions do occur in older people or people with a liver problem that do not completely produce a sufficient amount, and hence many supplement companies market Omega 3-6-9 blends. Almost all the polyunsaturated fat in the human diet is from EFA. Some of the food sources of omega-3, omega-6 and omega-9 fatty acids are fish, flaxseed (linseed), hemp oil, soya oil, canola oil (rapeseed oil), chia seed, pumpkin seed, sun flower seeds oils, leafy vegetables, walnuts and olive oil. Essential Fatty Acid (EFA) deficiency and imbalance causes heart attacks, stroke and obesity.

Medium chain fatly acids (C₆-C₁₂) Coconut oil consists predominantly of 65% medium chain fatty acids (MCFA). MCFAs are metabolized rapidly in the liver to energy and do not participate in the biosynthesis and transport of cholesterol. Coconut oil, in fact, tends to raise the HDL and lower the LDL:HDL ratio. Coconut oil is not deposited in adipose tissues and therefore does not lead to obesity. It is primarily an energy supplier and as fast in supplying of energy as sugar. MCFAs therefore differ in their metabolism from all the long chain fatty acids, whether saturated or unsaturated.

Diet food in terms of the present invention refers to any food or drink which has been altered in some way to make it part of a body modification diet, in particular weight loss.

Functional food in terms of the present invention includes whole foods and fortified, enriched or enhanced foods having a potentially beneficial effect on health when consumed as part of a varied diet on a regular basis, at effective levels.

The inventive functional food composition can be present in diverse forms. In particular, it can be present as a solid a powder, a semisolid, a crème, a gel, a liquid, a suspension or an emulsion.

The inventive functional food composition can be provided in containers where water is added by the client according to the desire. Another option is to provide the preparation ready to eat when water is added to obtain the optimal taste.

Without wishing to be limited by theory, one proposed mechanism for weight loss might be due to gelation of the food product with the food, which makes food partially indigestible, or decrease rate of digestion in the gastrointestinal tract. Thus, food will not be absorbed easily. Another proposed mechanism could be due to doing some laxative effect.

In various embodiments, the absorbed materials of the composition can be beneficial to the body and can have a have a neutral or beneficial effect on weight gain or health.

In addition to its use as bulk enhancing agent, citric acid can be used in the inventive functional food composition for alternative purposes, for example as an acidity regulator.

The inventive functional food composition is not limited in the choice of the flavour. Any flavouring or flavour enhancing substance which is safe for use in food compositions can be chosen according to the invention.

Additional features and advantages of the present invention will be apparent from the following detailed description on the basis of examples with reference to the drawings, wherein

FIG. 1 shows decrease in body weight in percent for obese rats taking one treatment per day of the inventive composition (test group, 2 ml) versus water (control group, 2 ml) given by gastric gavage for about 2 weeks.

FIG. 2 shows change from initial values of food intake, water consumption and feces weight in percent for obese rats taking an oral treatment of the inventive composition (test group, 2 ml) versus water (control group, 2 ml) by gastric gavage for about 2 weeks

### EXAMPLES

### Example 1

Different optimized formulas were prepared as summarized in Table 1

TABLE 1
Food product components and their weight percentages

| Item | % wt | F1 | F2 | F3 | F4 | F5 | F6 | F7 | F8 | F9 | F10 |
|---|---|---|---|---|---|---|---|---|---|---|---|
| Thickening | Na alginate | 20.23 | 16.87 | 13.21 | 9.21 | 7.07 | 4.83 | 3.90 | 3.43 | 2.47 | 1.00 |
| agent | | | | | | | | | | | |
| Bulk Enhancing | Citric acid | 1.21 | 1.27 | 1.32 | 1.38 | 1.41 | 1.45 | 1.46 | 1.47 | 1.48 | 1.51 |
| agent (1) | | | | | | | | | | | |
| Raising | Sodium | 0.61 | 0.63 | 0.66 | 0.69 | 0.71 | 0.72 | 0.73 | 0.73 | 0.74 | 0.75 |
| agent (2) | bicarbonate | | | | | | | | | | |
| Edible | Mixture of olive, | 6.07 | 6.33 | 6.61 | 6.91 | 7.07 | 7.24 | 7.31 | 7.35 | 7.42 | 7.53 |
| oil mixture | coconut and lin- | | | | | | | | | | |
| | seed oils (1:1:1 | | | | | | | | | | |
| | w/w/w) | | | | | | | | | | |
| Surfactant | Polysorbate 80 | 0.40 | 0.42 | 0.44 | 0.46 | 0.47 | 0.48 | 0.49 | 0.49 | 0.49 | 0.50 |
| Aqua | Water | 60.70 | 63.26 | 66.05 | 69.09 | 70.72 | 72.43 | 73.14 | 73.49 | 74.22 | 75.34 |
| Flavoring | Many flavors | 0.40 | 0.42 | 0.44 | 0.46 | 0.47 | 0.48 | 0.49 | 0.49 | 0.49 | 0.50 |
| agent | | | | | | | | | | | |
| Sweetener | Aspartame | 0.04 | 0.04 | 0.04 | 0.05 | 0.05 | 0.05 | 0.05 | 0.05 | 0.05 | 0.05 |
| (1) | | | | | | | | | | | |
| Sweetener | Glycerin | 10.12 | 10.54 | 11.01 | 11.52 | 11.79 | 12.07 | 12.19 | 12.25 | 12.37 | 12.56 |
| (2) | | | | | | | | | | | |
| Preservative | Sodium benzoate | 0.20 | 0.21 | 0.22 | 0.23 | 0.24 | 0.24 | 0.24 | 0.24 | 0.25 | 0.25 |
| | Total | 100 | 100 | 100 | 100 | 100 | 100 | 100 | 100 | 100 | 100 |

The formulations mentioned above resulted in production of emulgel structure which would be suitable to be used as antiobesity functional food composition.

A) Ready to Use Preparation (Oral Emulgel)

All the ingredients were mixed. Water was added mixed vigorously to form a gel-like structure. The prepared gel was kept in well-closed containers. The according gel product is ready to be used.

B) In-Situ Preparation (Oral Emulgel)

All the ingredients were mixed. Water can be added to the container once it is desired to make the gel by the consumer. Water is added and mixed using a spoon for 1-3 minutes. The gel reaction occurs and the formed gel will be ready to use.

### Example 2

Influence on the inventive composition on weight reduction

The functional food composition was tested for its capability in weight reduction. Based on desirable texture of all formulations, F8 according to Example 1 was used for the experiments.

Primary objective: To test the efficacy of an oral food treatment in body weight reduction using animals (rat model).

Secondary objective: To have an idea about mechanism of weight reduction. In addition, to get an idea about safety of the product.

Male albino rats, weighing 300-400 g were used. Animals were deprived of food for 12 h before the beginning of the experiments. The animals were divided into two groups; each experimental group consisted of 10 animals. The first group of animals received a volume of 2.0 ml of the inventive functional food composition orally. The second group of animals served as control and received an equivalent volume of water. Immediately after treatment, the animals were housed individually in cages.

The animals had free access to food and water.

All experiments were performed in an animal room under room temperature (about 22° C.). For a period of about 2 weeks the animal individual weight, food intake, water consumption and feces weight were measured every day. The results are summarized in FIGS. 2 and 3.

The initial values for the rat weight, food consumption, water-intake and feces weights are used for comparison. Generally in days 1-8, for the test group food consumption increased in comparison to the control group. This may be due to feeling hungry. However, food consumption did not have a significant impact in body weight in comparison to the control group since most of the food was lost via feces. In case of control group rats, got adapted and continued taking food with an increasing pattern. This could be a result of the increase of their body weight.

In days after 8-13, in the test group the rats adapted the new situation and according to their previous experience eating food was not highly favored. After this period and due to less food consumption and due to the large amount of food lost in their feces, a significant weight loss was observed for the rats after approximately 2 weeks in comparison to the control group

None of the rats died due to food product and there was no indication of intolerance to this food product

The food caused decreasing of the body weight of rats significantly when compared with the control group.

### Example 3

### Taste Evaluation

To evaluate the palatability of the formulated anti-obesity emulgel Nutella® spread chocolate was used as reference material and evaluated via 10 adult subjects.

Participants eligibility criteria included an age between 20-60 years. Volunteers featured no impaired perception towards taste. Gender eligible in the study was guaranteed.

To assess the taste ability in detecting the intensity of preparation texture and taste and to train the volunteers, standard Nutella ® with a range of concentrations (diluted with water) was prepared. Volunteers were instructed to conduct the taste assessment using the scaling. Subjects were asked to keep the standard solutions in their mouth for a few seconds and to subsequently rate the palatability (in terms of taste and texture) intensity of each standard concentration based on numerical scales that range from 1-5, where, suitable texture is given to number 1 and extremely not acceptable to 5. After the volunteers got trained on Nutella® the test compositions (antiobesity emulgel) were also evaluated similarly (chocolate, banana, cheese, pizza, straw berries, honey, orange).

Procedure: Anti-obesity emulgel formula without flavoring agent and sweetening agent (control), anti-obesity with sweetening agents and different flavors (chocolate, banana, cheese, pizza, straw berries, honey, orange) (test formulae) and Nutella ® as a reference food material with extreme palatability (reference) were provided randomly to 10 volunteers. Palatability was determined by single administration. Before tasting the samples, volunteer were advised to refrain from eating, chewing gum and drinking (except water) at least half an hour before tasting the samples. Each volunteer was given 2-3 ml of sample. Subjects scored the intensity of palatability by placing the given amount of sample on the tongue for a few seconds to provide time for evaluation. Each volunteer judged the taste of the samples on numerical scale, assess according to its degree of palatability in comparison to Nutella as a reference for chocolate flavored anti-obesity emulgel preparation. After tasting the sample, the subjects gargled their mouths well with water and waited for at least 20 minutes before tasting the next sample. Volunteer's degree of assessment for the standard reference Nutella was compared with their score scaling assessment for the samples. Evaluation was conducted within the subjects not across the subjects as the ability of taste perception of subjects might vary among them.

Based on the scores obtained for the anti-obesity emulgel in comparison to a commercial available food product (as in Table 2) it is shown that the material has a relatively pleasant taste upon the addition of suitable flavoring agents.

The anti-obesity emulgel can be supplied with different flavors depending on the desire of the clients. It is shown from the results in Table 3 that some flavors would be more suitable than others.

TABLE 2
Taste evaluation of the anti-obesity emulgel with chocolate
flavor (F8) in comparison to a reference commercial
product cream (Nutella ®)

| | | | | % | |
|---|---|---|---|---|---|
| Volunteer | | | % palatability | palatability | Normal- |
| # | Nutella ® | Test | Nutella | test | ization |
| 1 | 4 | 3 | 80 | 60 | 75 |
| 2 | 5 | 4 | 100 | 80 | 80 |
| 3 | 5 | 4 | 100 | 80 | 80 |
| 4 | 4 | 3 | 80 | 60 | 75 |
| 5 | 5 | 5 | 100 | 100 | 100 |
| 6 | 5 | 5 | 100 | 100 | 100 |
| 7 | 3 | 3 | 60 | 60 | 100 |
| 8 | 5 | 4 | 100 | 80 | 80 |
| 9 | 5 | 4 | 100 | 80 | 80 |
| 10 | 4 | 3 | 80 | 60 | 75 |
| average | | | 90 | 76 | 84.4 |

Nutella ® is the brand name of a chocolate spread, manufactured by the Italian company Ferrero.
Normalization: dividing the % palatability of test to the % palatability of reference per each subject.

TABLE 3
Taste evaluation of anti-obesity emulgel preparations (F8) prepared
with different flavoring agents

| | % Pal | % Pal | % Pal | % Pal | % Pal | % Pal | % Pal |
|---|---|---|---|---|---|---|---|
| Volunteer # | (1) | (2) | (3) | (4) | (5) | (6) | (7) |
| 1 | 80 | 100 | 80 | 40 | 100 | 40 | 80 |
| 2 | 100 | 80 | 60 | 40 | 80 | 80 | 100 |
| 3 | 100 | 80 | 80 | 60 | 100 | 60 | 40 |
| 4 | 80 | 100 | 100 | 40 | 60 | 60 | 60 |
| 5 | 100 | 100 | 60 | 100 | 80 | 40 | 80 |
| 6 | 100 | 80 | 60 | 60 | 60 | 20 | 80 |
| 7 | 60 | 60 | 40 | 40 | 80 | 40 | 40 |
| 8 | 100 | 80 | 60 | 60 | 80 | 20 | 80 |
| 9 | 100 | 100 | 100 | 60 | 80 | 20 | 60 |
| 10 | 80 | 60 | 80 | 80 | 60 | 60 | 40 |
| average | 90 | 84 | 72 | 58 | 78 | 44 | 66 |

The used flavoring agents: 1—chocolate, 2—banana, 3—cheese, 4—pizza, 5—straw berries, 6—honey, 7—orange

The features disclosed in the foregoing description, the drawings and in the claims may, both separately and in any combination thereof, be material for realizing the invention in diverse forms thereof.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . . ”

### Concepts

1. A functional food composition comprising:
   a thickening agent in an amount from 0.1 to 50% by weight;
   a raising and/or a bulk enhancing agent in an amount from 0.1 to 10% by weight;
   an edible oil in an amount from 0.1 to 20% by weight;
   an additive selected from the group consisting of flavor, surfactant, sweetener, preservative and coloring agent; and
   water in an amount from 20 to 90% by weight.
2. The functional food composition according to claim 1, wherein the thickening agent is carboxymethyl cellulose or alginate in the acid, salt or ester form.
3. The functional food composition according to claim 1, wherein the raising agent is a carbonate and/or a bicarbonate.
4. The functional food composition according to claim 1, wherein the bulk enhancing agent is citric acid.
5. The functional food composition according to claim 1, wherein the edible oil comprises medium chain fatty acids or essential fatty acids.
6. The functional food composition according to claim 1, wherein the flavor is citric acid, chocolate flavor, banana flavor, cheese flavor, pizza flavor, strawberry flavor, honey flavor and/or orange flavor.
7. The functional food composition according to claim 1, wherein the surfactant is polysorbate 20, polysorbate 40, polysorbate 60, polysorbate 65 and/or polysorbate 80.
8. The functional food composition according to claim 1, wherein the sweetener is aspartame and/or glycerin.
9. The functional food composition according to claim 1, wherein the preservative is sodium benzoate.
10. Use of the functional food composition according to claim 1 as a diet food or as an ingredient in diet food.
11. Use of the functional food composition according to claim 1 for enhancing the palatability of a diet food.
12. The functional food composition of claim 1, wherein the thickening agent is present in an amount of 1 to 20% by weight.
13. The functional food composition of claim 1, wherein the raising and/or bulk enhancing agent is present in an amount of 0.5 to 3% by weight.
14. The functional food composition of claim 1, wherein the edible oil is present in an amount of 2 to 10% by weight.
15. The functional food composition of claim 3, wherein the raising agent is sodium bicarbonate.
16. The functional food composition of claim 1, wherein the edible oil comprises olive oil, coconut oil or linseed oil.
17. The functional food composition of claim 1, wherein the edible oil is selected from the group consisting of essential fatty acids and medium chain fatty acids.

We claim:

1. A functional food composition comprising:
a thickening agent in an amount from 0.1 to 50% by weight;
a raising and/or a bulk enhancing agent in an amount from 0.1 to 10% by weight;
an edible oil in an amount from 0.1 to 20% by weight;
an additive selected from the group consisting of flavor, surfactant, sweetener, preservative and coloring agent; and
water in an amount from 20 to 90% by weight.

2. The functional food composition according to claim 1, wherein the thickening agent is carboxymethyl cellulose or alginate in the acid, salt or ester form.

3. The functional food composition according to claim 1, wherein the raising agent is a carbonate and/or a bicarbonate.

4. The functional food composition according to claim 1, wherein the bulk enhancing agent is citric acid.

5. The functional food composition according to claim 1, wherein the edible oil comprises medium chain fatty acids or essential fatty acids.

6. The functional food composition according to claim 1, wherein the flavor is citric acid, chocolate flavor, banana flavor, cheese flavor, pizza flavor, strawberry flavor, honey flavor and/or orange flavor.

7. The functional food composition according to claim 1, wherein the surfactant is polysorbate 20, polysorbate 40, polysorbate 60, polysorbate 65 and/or polysorbate 80.

8. The functional food composition according to claim 1, wherein the sweetener is aspartame and/or glycerin.

9. The functional food composition according to claim 1, wherein the preservative is sodium benzoate.

10. Use of the functional food composition according to claim 1 as a diet food or as an ingredient in diet food.

11. Use of the functional food composition according to claim 1 for enhancing the palatability of a diet food.

12. The functional food composition of claim 1, wherein the thickening agent is present in an amount of 1 to 20% by weight.

13. The functional food composition of claim 1, wherein the raising and/or bulk enhancing agent is present in an amount of 0.5 to 3% by weight.

14. The functional food composition of claim 1, wherein the edible oil is present in an amount of 2 to 10% by weight.

15. The functional food composition of claim 3, wherein the raising agent is sodium bicarbonate.

16. The functional food composition of claim 1, wherein the edible oil comprises olive oil, coconut oil or linseed oil.

17. The functional food composition of claim 1, wherein the edible oil is selected from the group consisting of essential fatty acids and medium chain fatty acids.
